(19) United States
(12) Patent Application Publication
(10) Pub. No.: US 2006/0033625 A1
(43) Pub. Date: Feb. 16, 2006

(54) DIGITAL ASSURANCE METHOD AND SYSTEM TO EXTEND IN-HOME LIVING

(75) Inventors: CHRISTOPHER DONALD JOHNSON, CLIFTON PARK, NY (US); PAUL KENNETH HOUPT, SCHENECTADY, NY (US); MICHAEL R. LABLANC, WILTON, NY (US); JONATHAN DAVID POTTER, SOUTHINGTON, CT (US)

Correspondence Address: DYKEMA GOSSETT PLLC, 2723 SOUTH STATE STREET, SUITE 400, ANN ARBOR, MI, 48104, US

(73) Assignee: GENERAL ELECTRIC COMPANY, SCHENECTADY, NY (US)

(21) Appl. No.: 10/710,899

(22) Filed: Aug. 11, 2004

(51) Int. Cl. G08B 23/00; G06Q 10/00; G06Q 40/00

(52) U.S. Cl. 340/573.1; 340/573.4; 705/2; 705/4

(57) ABSTRACT

A system and method for facilitating in-home living by monitoring and analyzing in-home activities, and thereby implementing services for facilitating such living. The system includes an integrated portfolio of active and/or passive sensors for monitoring activities of an individual, and an analyzing system for synthesizing and analyzing signals from the sensors for thereby assessing a status of the individual and inferring the individual's quality of life. The system further includes a decision making system for generating an output based upon the assessment, and an activation system for activating processes to respond to the decision making.

### BACKGROUND OF INVENTION

a. Field of Invention

The invention relates generally to a method and system for facilitating in-home living, and more particularly to such a method and system that monitors and analyzes the activities related to physical health, and thereby implements services for facilitating better care or living in venues spanning the home to institutions.

b. Description of Related Art

Factors such as the environment, safety, health, mental capacity and/or physical frailty diminish the ability of certain people to function independently in their homes. Individuals and care providers have an interest in helping to assure acceptable living environments for clients, relatives and friends. For people who cannot function independently in their homes, services may be brought directly to the person's home or the subject person may be entirely removed from the home and placed in an assisted care environment. For in-home care where services can be relatively expensive, it is desirable to both lower the cost of in-home care and further facilitate the ability of a person to remain in their home, as opposed to being placed in an institution.

In the past, attempts have been made to facilitate a person's ability to stay home by devices such as home security systems, lock boxes, videos, panic buttons, and personal service offerings. Insurance is provided for home, health and long-term care. Whereas such systems and techniques ordinarily provide independent functions, such as sensing, paging or servicing, the ability for these systems to operate in an integrated system involving sensing, analyzing, processing and thereby implementing specified actions has thus far been virtually non-existent. Other methods for promoting in-home living include service providers, family and friends supporting individual(s) via phone calls, visits, mail and other means to coordinate their care. It is often the case however that such needy individuals are remote and are therefore highly reliant on other individuals to assess their living and/or physical conditions.

Even if individuals require assistance in living, they still desire autonomy, maintenance of their familiar environment, as well as the desire to remain in the home. Since it is typically desirable to both lower the cost of in-home care as well as to enable an individual to remain in their home versus an institution, there exists a need for adequate and cost effective technology to enable an individual to remain in their home.

In the institutional context, various levels of monitoring and services are needed for the various conditions of an individual being cared for. For example, in a hospital, care is generally provided on a continuum of intense emergency to reduced care requiring general monitoring and observation. In assisted living venues, care is generally provided from total physical dependency to reduced care requiring cooked meals or simple social interaction. In these various institutional venues, there is a cost for providing the care offered, which makes it desirable to provide the right level of care, accurately and cost effectively. From the viewpoint of persons providing care, as well as persons and institutions paying for such care, it would be of benefit if such care were cost effective and accurate.

Insurance is provided for home, health and long-term care to cover the high expense of those desiring care due to diminished capacity. Insurance and re-insurance is also provided to institutions for liability associated with care provision.

As briefly discussed above, in the art, there exist technology for facilitating a person's ability to stay home by devices such as home security systems, lock boxes, videos, panic buttons, and personal service offerings. Moreover, general sensor technologies exist for detecting motion, temperature, flow, biometrics, and physical states. There also exist the general methods of processing data, such as control systems for data organization, workflow, internet and other communications, as well as services for intrusion, fire and medical emergency detection, alarm and notification.

What the art lacks however, is the technology for integration of sensing, decision making algorithms, stakeholder processes, other service providers, validation, active and passive notification and control for the purpose of enhancing the quality of life for in-home living. Additionally, the art lacks the provision of insurance services offered with the requisite incentives to offer better care per unit cost.

It would therefore be of benefit to provide an integrated method and system for monitoring and analyzing in-home activities, and thereby implementing services for facilitating in-home living. There also remains a need for a method and system for extending in-home living, which is robust in design, efficient to operate, simple to install, and economically feasible to implement. In the context of this disclosure, “in-home” is exemplary of improving and/or extending care in home and institutional venues.

### SUMMARY OF INVENTION

The invention solves the problems and overcomes the drawbacks and deficiencies of prior art home assist techniques by providing an integrated method and system for monitoring and analyzing in-home activities, and thereby implementing services for facilitating in-home living.

An exemplary technical effect of the digital assurance system according to the present invention would be to provide a method and system for improving the analysis of signals from a portfolio of sensors in a home or institutional setting, and further improving the decision making and response options to such an analysis.

The present invention specifically provides products and services for health networks, hospitals, insurance, service providers and individuals, and may be applicable to the inferencing of activities for consistency related to the condition of the monitored persons, animals or physical space. The present invention synthesizes data from which the quality of life for an occupant or a physical area may be inferred, and utilizes activities using an integrated portfolio of active and passive sensors, sensing systems, networked systems and processes, call center, individuals, service processes, algorithms and various communications methods to create the inferences. Decisioning may be performed for stakeholder information, inference validation and control of the environment.

The present invention thus eliminates many of the reasons certain demographics must leave the comfort and safety of familiar environments for new environments that are more costly or uncomfortable. Beyond reduced anxiety, as well as enhanced habitability, safety and enjoyment of the living environment, value is derived from reduced medical and/or assisted care, occupant risk reduction and new service offerings for insurance and hardware providers.

The invention thus helps enable the extension of in-home living for people who would prefer to stay in their home versus an assisted living arrangement, and helps enable better care in facilities and homes because of the highly monitored physical environment and personal assessment coupled to decisioning algorithms that assess activity and care rules, temporal and spatial reasoning and a global case history. Thus more services may be provided with fewer people to support those being monitored, and safer living conditions may be attained with all of the separate advantages afforded by security, medical and operations monitoring being augmented and integrated with data acquisition and decisioning algorithms.

In general, the invention first assesses conditions that lead to in-home quality of life assurance and keeps stakeholders efficiently involved through active and passive data acquisition, decisioning, communication and control. The invention provides a portfolio of measuring devices and user interfaces for sensing physical conditions, and the collection of data from a number of sources within the care environment. These data include telecommunications, power, gas, water, motion, contacts on perimeter barriers, contacts on cabinets, appliances and devices, motion, temperature, humidity, sound, biomedical, user interfaces and the like. The values, readings, trends, and pattern recognition inside the scope of the present invention may include data related to the environmental envelope such as power use, gas use, water use, video, motion, access, biometrics, HVAC, medicine dose, thermography, man/machine interfaces and call centers.

The invention includes a portfolio of passive activity monitoring, as well as active user and device interaction for sensing mental conditions. Examples of these data and interactive system components include automated voice, touch and home physical system input/output sensors such as infrared or ultrasonic motion detectors for detecting occupant movement. Should an anomalous pattern of activity be detected, a voice or electronically instantiated query, sound, optical or motion would be generated as could a vibrating device carried by the occupant be activated. The occupant may then respond verbally or by activating a switch. Appliances and physical apparatus may also be integrated. Examples include user pattern recognition embedded in devices used in daily routines such as medical apparatus, entertainment including TV, radio, telephones, and user I/O devices such as a touch screen or pad, appliance interlocks, physical device interlocks, all of which may be controlled to seek user facility in passive use and/or in active logic.

For the present invention, data may be turned into information relating to activity, health, safety and environmental assurity. This may be accomplished by combining the inputs of the portfolio of sensing apparatus with activity models and pattern recognition to score the monitored person's activities and well-being. Decision rules may automatically notify call center personnel, other designated parties and subroutines pending the digital assessments being made against decision criteria. These decision criteria are learned pattern and experiential based rules. Processes may be managed by digital workflow, and systems may be remotely and on site adjusted pending the assessments.

Building envelope assessments may be made via deterministic rules associated with security, fire, atmosphere, access and monitored apparatus status. Further, data patterns may be assessed and synthesized. For example, gas on and thermography detection of stove heat in kitchen and lack of movement for an abnormal duration would generate an alert, where the action may be to contact a call center or request in-home feedback. Therefore, an important feature is not only the correct sensing mechanisms, but also the algorithms and infrastructure to assess the environment and occupant's status. By enabling assessments such as this, mobile or distributed services can be more productive and in-home living can be extended.

For the present invention, the fact that the assisted living expense can be reduced has direct bearing on medical claims, long term care insurance and out of pocket expenses associated with care and monitoring. For service providers, quality of care increases while at the same time lowering cost, whereby the present invention enables new insurance products that can be priced for a new class of exposures.

Exemplary embodiments of the invention include its use to improve quality of care in a managed care facility, a means by which an individual(s) may live in their home versus managed care, a means by which more effective services can be provided in venues such as nursing, charity, remote care for a loved one, as a security and/or life insurance product. While any of these and many more beneficial applications are enabled, a description of the digital assurance integrated into the service offering of a long term care product line will be used to illustrate a number of application concepts to further expound on the benefits of the present invention.

As briefly addressed above, a number of insurance businesses offer long term care. These businesses have multitudes of product configurations. One exemplary configuration is to pay benefits to defray care costs experienced by a client when such time may come as the client is impaired. The care options are generally scaled to the degree of impairment and typically include institutionalization at a skilled nursing care operation when a number of a client's daily activity living skills have been compromised. A benefit cap typically binds the cost of such care. It is therefore desirable from both the insurance company and from the client's perspective that institutional care be postponed as long as possible. For the client, the familiarity and comfort of home is of a higher, more preferred quality of life than that of managed care in an institution. For the insurance provider, in-home cost can be lower and by extending the stay in home, the benefit period can be extended and/or its costs lowered. Additionally, for an insurance provider, it is a competitive advantage to offer a robust in-home offering and market a quality of life product as opposed to one focused on institutional care alone. For the maker and service providers of the disclosed digital assurance platform for the present invention, there exists a new market and profit incentives consistent with a culture of enhancing life with imaginative solutions. Family, friends and care stakeholders benefit from knowing the living condition in a vastly deeper, more insightful, more accurate way while at the same time being less intrusive than prior art related systems and methods would enable.

A potential insurance solution/service offering is the extension of in-home living paid for as part of a premium and/or benefit claim. In this regard, the present invention discloses a digital assurance feature which enables safer distributed care into a client's home because active inferencing of the client's state of health and living status is available to stakeholders such as relatives and service providers, but not limited to, as home nursing, meals, medical device, laundry, hospice etc. For these service providers, more clients can be served per unit cost since services are more demand based than scheduled, or a higher level of care can be attained per given scheduled service cycle. Additionally, claims payment mistakes and in some instances, fraud, are reduced from the monitoring of activity book of the insured for impairment validation and for care providers delivering the expected services.

The disclosed digital assurance system would be beneficial beyond the individual insurance policy holder. For example, an institution's ability to monitor conditions and care may reduce risk for which the institution is insured. It would therefore be possible to decrease premiums or structure a new class of insurance product. Additionally, reinsurance of liabilities associated with policies and portfolios utilizing the disclosed method and system would become more accurate and therefore lead to new products or premiums.

The invention achieves the aforementioned exemplary aspect by providing a system for facilitating living in a predetermined location for an individual. The system may include an integrated portfolio of active and/or passive sensors for monitoring activities of the individual, and an analyzing system for synthesizing and analyzing signals from the sensors for thereby assessing a status of the individual and inferring the individual's state, status and/or quality of life. The system may further include a decision making system for generating an output based upon the assessment, and an activation system for activating processes to respond to the output from the decision making system.

Activities associated with living may be monitored for the purpose of inferring physical status. For the system described above, the exemplary sensors may be capable of sensing contact, sound, vibration, temperature, humidity, video, motion, access, location, telecommunications, computer traffic, HVAC, power, flow of utility services, appliance status, thermography, biometric monitoring and/or man/machine interfaces. The sensors may monitor usage of appliance, Hi-Fi, alarm, television, radio, computer, exercise equipment and/or medical equipment for assessment of health, activity and/or safety of the individual.

The analyzing system may include algorithms, rules engines, decision making systems and/or workflow to convert raw data from the sensors into probabilistic assessment of health, activity and/or safety of the individual. The analyzing system may utilize Artificial Intelligence, Case Based Reasoning, Evidential Reasoning, Data Mining, Rule Base Decisioning, Fuzzy Logic, Agent Based, System Dynamic, Discrete Event Model Based Decisioning, Bayesian statistical inference and/or Monte Carlo Simulation in its reasoning. The analyzing system may utilize data from at least two of the sensors for assessing the status of the individual and inferring the individual's quality of life, status, condition, security and/or health state. The assessment of status may be used to probabilistically or deterministically determine if an activity is normal or an anomaly, such that if the activity is normal as defined by a probability set-point, then the decision making and activation systems label the activity as normal, but if the activity is an anomaly, the decision making and activation systems perform contacting the individual and/or sending assistance to the individual. The analyzing system may be configured to allow a period of learning and automated or installer assisted tuning of anomaly pattern classification thresholds in the initial setup, following major changes (e.g. a hospitalization followed by home recovery) and slower time horizon learning. Longer time horizon learning will allow incorporation of false alarms and missed crisis events to condition thresholds to achieve reliable and appropriate alarm classification in each unique home and unique occupant setting. Other adaptation of individual home settings may reflect learning from the larger data base of similar experiences in deterministically or statistically similar settings. For example clients with diagnosed dementia, Parkinson's, stroke mobility impairment, partial paralysis or other factors affecting mobility may suggest the best paradigms for anomaly detection with the fewest false alarm rates. Other insurance offerings follow this paradigm.

The anomaly detection methods disclosed herein may include adaptive detection thresholds, such that, the methods are used to characterize normal and anomalous behavior as projected onto the various observable suites (i.e. sensors, keyboards, HVAC, etc.). The anomaly detection methods may thus include adaptive detection thresholds, rules and models both following the initial installation (fast tuning) and over time (slow tuning) to incorporate experiential learning in the unique and particular setting of a client, for example, in order to incorporate pseudo (or actual) Bayesian learning from false alarms for missed crisis events. Updates or reinstantiated adaptation may follow, for example, known new impairments to the client (i.e. post operative, possibly temporary). Further, this adaptation may be customized based on the population in a centralized data base of clients with similar known impairments (and living environments, which includes the sensor portfolio), and that specifically, leveraging the learning and tuning in other situations may accelerate or improve the accuracy of the analyzing/decisioning logic over time. From a sensor portfolio installation perspective, this understanding acts as an additional feedback loop in the design and placement of the sensor suite within the client's environment (i.e. in order to detect the possibility that a client has fallen down a set of stairs, sensors may be utilized at the top and bottom of the stairs). There may also be an “outer” feedback loop that adds/removes sensing modalities and places the sensor within the environment.

The aforementioned system may be integrated with a health owner's insurance to reduce a cost of the insurance and/or enhance care at a given level of the insurance. The insurance may include a reduction in premium and/or increase in coverage for extension of in-home living by means of the system. The owner may be a home owner, an institution or an insurance company with or without reinsurance.

The system may facilitate living in a home of the individual, a hospital, an assisted care facility and/or an institution. The analyzing system may include a computer and/or a call center, located at a remote location from the predetermined location, for analyzing signals from the sensors. The decision making system may generate the output based upon the assessment of values, readings, trends, and/or pattern recognition from data related to power use, gas use, water use, video, motion, access, biometrics, HVAC, medicine dose, thermography, man/machine interfaces, computing platforms and/or call centers. The sensors may include automated voice, touch and/or home physical system input/output sensors.

The system may further include means for generating a voice or electronically instantiated query, sound, optical, motion and/or a vibration signal to the individual upon the detection of an anomalous pattern of activity. The means for generating signals may be integrated in a medical device, a device with a processor, a TV, radio, telephone, user I/O device, appliance interlock and/or physical device interlock. The processes being monitored and assessed may include remote and/or on site adjustment/calibration.

The system may further include a verification system for verifying the output by the decision making system for reducing the chance of a false decision. The system may utilize a dynamically configured spatial/volumetric simulation space, activity density, sequence and rate, spatial rate variation and/or activity-resource reconciliation for assessment of health, activity and/or safety of the individual based upon spatial and/or temporal inferencing. The system may include logical and/or reasoned rules for comparing a volumetric and temporal dynamic control volume for persons and activities of the individual. The system may also include a plurality of sensors for enabling reasoned inputs and validating reasoning results. The decision-making system may utilize RF and mobile tracking means for assessing the individual's quality of health.

The system may utilize appliance and utility use or flows to reason on health, safety and/or status of the individual and/or the individual's environment. The system may utilize simulation based modeling such as Agent, Discrete Event, System Dynamic, Monte Carlo and Scenario to reconcile time and/or space appropriateness in activity and status of the individual and/or the individual's environment. The system may also utilize mutually exclusive time and/or space continuums to reason and/or infer health and/or quality of life of the individual. The system may utilize a plurality of sensors for obtaining time and space logical inputs and outputs for inferring health, status and/or quality of life of the individual.

The system may further include automated and/or manual algorithm learning with training motions and activities to instantiate logic, algorithms and data baselines. The system may also include continuous learning from activity, sensed signals, reasoning and/or feedback for increasing reasoning accuracy. The system may yet further include product offerings that lower insurance and reinsurance cost for a given service and/or risk level. The system may also include means for utilization of more global data in comparative algorithms to assess attributes and context, the comparative wellness and/or activity state of one who is monitored, means for location of items tagged by RF based upon an automated command to locate and display, and/or means for checking activities against forecasted or scheduled activities in assessing fraud, compliance to contracted terms and conditions, an anomaly and/or an adequacy of care.

The invention yet further provides a decision making system for assessing signals from a plurality of sensors and generating a selective output from a plurality of potential outputs based upon the assessment. The sensors may be active and/or passive sensors. The system may include an integrated portfolio of the sensors for monitoring activities of an individual in a predetermined location, and an analyzing system for synthesizing and analyzing signals from the sensors thereby assessing a status of the individual and inferring the individual's state, status and/or quality of life. The decision making system may further include an activation system for activating processes to respond to the selective output from the decision making system. With the configuration described above, the decision making system facilitates living in the predetermined location for the individual.

For the decision making system described above, the sensors may be capable of sensing contact, sound, vibration, temperature, humidity, video, motion, access, location, telecommunications, computer traffic, HVAC, power, flow of utility services, appliance status, thermography, biometric monitoring and/or man/machine interfaces. The sensors may monitor usage of devices associated with activity such as medical apparatus, television, radio, computer, exercise equipment and/or medical equipment for assessment of health, activity and/or safety of the individual.

The analyzing system may include algorithms, rules engines and/or workflow to convert raw data from the sensors into probabilistic assessment of health, activity and/or safety of the individual. The analyzing system may utilize Artificial Intelligence, Case Based Reasoning, Evidential Reasoning, Data Mining, Rule Base Decisioning, Fuzzy Logic, Agent Based, System Dynamic, Discrete Event and/or Monte Carlo Simulation in its reasoning. The analyzing system may utilize data from at least two of the sensors for assessing the status of the individual and inferring the individual's quality of life, status, condition, security and/or health state. The assessment of status may be used to probabilistically or deterministically determine if an activity is normal or an anomaly, such that if the activity is normal as defined by a probability set-point, then the decision making and activation systems label the activity as normal, but if the activity is an anomaly, the decision making and activation systems perform contacting the individual and/or sending assistance to the individual.

The decision making system may be integrated with a health and/or owner's insurance to reduce a cost of the insurance and/or enhance care at a given level of the insurance. The insurance may include a reduction in premium and/or increase in coverage for extension of in-home living by means of the system. The owner may be a home owner, an institution or an insurance company with or without reinsurance.

The decision making system may facilitate living in a home of the individual, a hospital, an assisted care facility and/or an institution. The analyzing system may include a computer and/or a call center, located at a remote location from the predetermined location, for analyzing signals from the sensors. The decision making system may generate the output based upon the assessment of values, readings, trends, and/or pattern recognition from data related to power use, gas use, water use, video, motion, access, biometrics, HVAC, medicine dose, thermography, man/machine interfaces, computing platforms and/or call centers. The sensors may include automated voice, touch and/or home physical system input/output sensors.

The decision making system may further include means for generating a voice or electronically instantiated query, sound, optical, motion and/or a vibration signal to the individual upon the detection of an anomalous pattern of activity. The means for generating may be integrated in a medical device, a device with a processor, a TV, radio, telephone, user I/O device, appliance interlock and/or physical device interlock. The processes being adjusted may include remote and/or on site adjustment.

The decision making system may further include a verification system for verifying the output by the decision making system for reducing the chance of a false decision. The decision making system may utilize a dynamically configured spatial/volumetric simulation space, activity density, sequence and rate, spatial rate variation and/or activity-resource reconciliation for assessment of health, activity and/or safety of the individual based upon spatial and/or temporal inferencing. The decision making system may include logical and/or reasoned rules for comparing a volumetric and temporal dynamic control volume for persons and activities of the individual. The decision making system may also include a plurality of sensors for enabling reasoned inputs and validating reasoning results. The decision making system may utilize RF and mobile tracking means for assessing the individual's quality of health.

The decision making system may utilize appliance and utility use or flows to reason on health, safety and/or status of the individual and/or the individual's environment. The decision making system may utilize Agent Based and/or Discrete Event modeling to reconcile time and/or space appropriateness in activity and status of the individual and/or the individual's environment. The decision making system may also utilize mutually exclusive time and/or space continuums to reason and/or infer health and/or quality of life of the individual. The decision making system may utilize a plurality of sensors for obtaining time and space logical inputs and outputs for inferring health, status and/or quality of life of the individual.

The decision making system may further include automated and/or manual algorithm learning with training motions and activities to instantiate logic and data baselines. The decision making system may also include continuous learning from activity, sensed signals, reasoning and/or feedback for increasing reasoning accuracy. The invention may abstract norms and learn anomalies from the incorporation of a plurality of users and past decisioning. The decision making system may yet further include product offerings that lower insurance and reinsurance cost for a given service and/or risk level. The decision making system may also include means for utilization of more global data in comparative algorithms to assess attributes and context, the comparative wellness and/or activity state of one who is monitored, means for location of items tagged by RF based upon an automated command to locate and display, and/or means for checking activities against forecasted or scheduled activities in assessing fraud, compliance to contracted terms and conditions, an anomaly and/or an adequacy of care.

The invention yet further provides a method for facilitating living in a predetermined location for an individual. The method may include monitoring activities of the individual by means of an integrated portfolio of active and/or passive sensors, and synthesizing and analyzing signals from the sensors by means of an analyzing system for assessing a status of the individual and inferring the individual's quality of life, status or condition. The method may further include generating an output based upon the assessment by means of a decision making system, and activating processes to respond to the decision making by means of an activation system.

For the method described above, the method may include sensing contact, sound, vibration, temperature, humidity, video, motion, access, telecommunications, computer traffic, HVAC, power, flow of utility services, appliance status, thermography, biometric monitoring and/or man/machine interfaces by means of the sensors. The method may also include monitoring usage of devices typical of the monitored environment such as medical devices, television, radio, computer, exercise equipment and/or medical equipment for assessment of health, activity and/or safety of the individual. The method may further include converting raw data from the sensors into a probabilistic assessment of health, activity and/or safety of the individual by means of algorithms, rules engines, decision making systems and/or workflow in the analyzing system.

The methodology includes a comparative assessment to a broader, relevant population. Relevancy is determined by attribute similarity as familiar to those skilled in the art of Classification and Regression. The method may also include utilizing Artificial Intelligence, Case Based Reasoning, Evidential Reasoning, Data Mining, Rule Base Decisioning and Fuzzy Logic, Agent Based Simulation, System Dynamic Simulation, Discrete Event Simulation and/or Monte Carlo Simulation in its reasoning within the analyzing system. The method may further include utilizing data from at least two of the sensors for assessing the status of the individual and inferring the individual's quality of life, security, health and/or status by means of the analyzing system. The method may include utilizing the assessment of status to probabilistically or deterministically determine if an activity is normal or an anomaly, and if the activity is normal, using the decision making and activation systems to label the activity as normal as defined by a probability set-point, but if the activity is an anomaly, using the decision making and activation systems to perform at least one of logging the anomalous condition for further use, probing for feedback/validation, contacting the individual and sending assistance to the individual. “Normal” is configurable for the person being assisted on an absolute, discrete basis or comparatively to a population with similar and selectable attributes.

The method may include integration thereof with a health and/or owner's insurance to reduce a cost of the insurance and/or enhance care at a given level of the insurance. The method may also include reducing premium for the level of insurance for extension of in-home living by means of the method. The owner may be a home owner, an institution or an insurance company with or without reinsurance. The method may thus facilitate living in a home of the individual, a hospital, an assisted care facility and/or an institution. The method would extend to institutional policy holders.

The method may include providing a call center located at a remote location from the predetermined location for analyzing signals from the sensors. The method may also include generating the output based upon the assessment of values, readings, trends, and pattern recognition from data related to power use, gas use, water use, video, motion, access, biometrics, HVAC, medicine dose, thermography, man/machine interfaces, computational platform and/or call centers by means of the decision making system. The sensors may include automated voice, touch and/or home physical system input/output sensors.

The method may further include generating a voice or electronically instantiated query, sound, optical, motion and/or a vibration signal to the individual upon the detection of an anomalous pattern of activity. The feedback mechanism may be integrated into devices associated with the assisted person's environment such as a medical device, a device with a processor, a TV, radio, telephone, user I/O device, appliance interlock and/or physical device interlock. The processes being monitored may include having a remote location and/or an on site location.

The method may also include verifying the output by the decision making system for reducing the chance of a false decision, and assessing health, activity and/or safety of the individual based upon spatial inferencing by utilizing a dynamically configured spatial/volumetric simulation space, activity density, sequence and rate, spatial rate variation and/or activity-resource reconciliation. The method may utilize logical and/or reasoned rules for comparing a volumetric and temporal dynamic control volume for persons and activities of the individual. The method may utilize a plurality of sensors for enabling reasoned inputs and validating reasoning results. The decision making system may utilize RF and/or mobile tracking means for assessing the individual's quality of health.

The method may utilize appliance and utility use or flows to reason on health, safety and/or status of the individual and/or the individual's environment. The method may also utilize Agent Based Modeling to reconcile time and/or space appropriateness in activity and status of the individual and/or the individual's environment. The method may utilize mutually exclusive time and space continuums to reason and/or infer health and/or quality of life of the individual. The method may further utilize a plurality of sensors for obtaining time and space logical inputs and outputs for inferring health, status and/or quality of life of the individual. The method may include automated and/or manual algorithm learning with training motions and activities to instantiate logic and data baselines. The method may also include continuous learning from activity, sensed signals, reasoning and/or feedback for increasing reasoning accuracy. The method may yet further include product offerings that lower insurance and/or reinsurance cost for a given service or risk level. The method includes comparison of a discrete monitored instance to a broader population. The method may be utilized across a plurality of monitored persons to enable and perform comparative assessments and reasoning. The method may also include utilizing more global data in comparative algorithms to assess attributes and context, the comparative wellness and/or activity state of one who is monitored, locating items tagged by RF based upon an automated command to locate and display, and/or checking activities against forecasted or scheduled activities in assessing fraud, compliance to contracted terms and conditions, an anomaly and/or an adequacy of care.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 illustrates a long term care business system where the digital assurance system according to the present invention may be used advantageously;

FIG. 2 illustrates a system logic flow block diagram of the subsystems of the digital assurance system according to the present invention;

FIG. 3 illustrates various sources of data in an exemplary embodiment of a home;

FIG. 4 illustrates a block diagram of the relationships wherein the digital assurance system according to the present invention seeks, collects and organizes data, then performs logic operations and calculations before notification of stakeholders involved in the care or security;

FIG. 5 illustrates a flowchart for the method used to convert sensor data into an activity inference;

FIG. 6 illustrates the concept according to the present invention whereby agent based simulation with a dynamic control volume technique is utilized to derive spatial inferencing; and

FIG. 7 illustrates the logic of applying time differencing, control chart, time series and discrete event.

### DETAILED DESCRIPTION

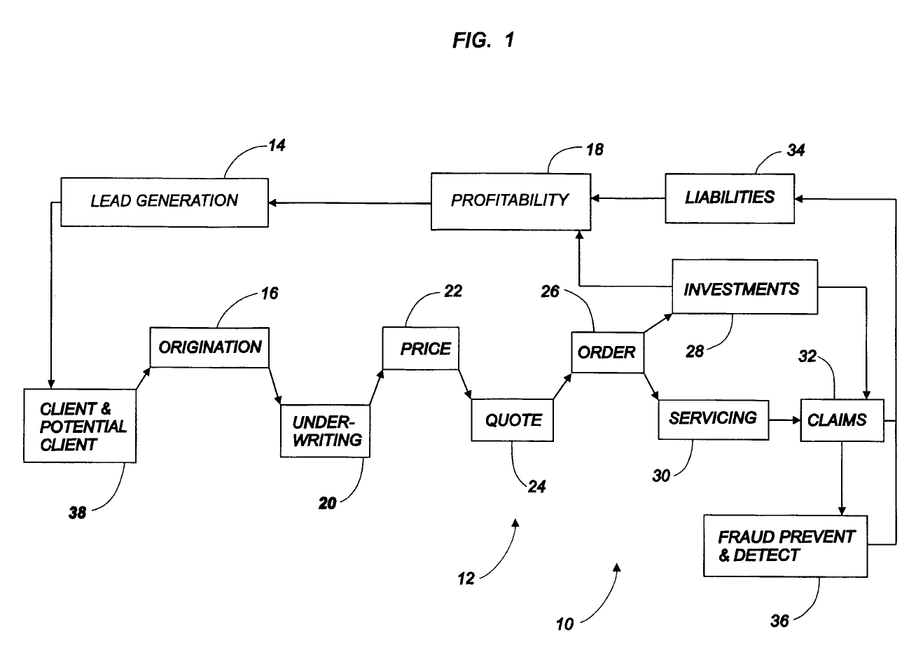

Referring now to the drawings wherein like reference numerals designate corresponding parts throughout the several views, FIGS. 1-7 illustrate the method and system for facilitating in-home living according to the present invention, generally designated digital assurance system 10. Before proceeding further, it should be noted that although the present invention is disclosed for an in-home setting, the in-home setting is described for exemplary purposes only, and those skilled in the art would readily appreciate in view of this disclosure that the present invention could also be applicable to an institutional or related settings. Additionally, in order to further facilitate the description and application of the present invention, by way of example only, various aspects of the invention discussed below will be described in their application to the assessment of an individual's health, safety and status for an in-home setting.

Briefly, as described in greater detail below, digital assurance system 10 may first assess conditions that lead to in-home quality of life assurance. These conditions may be sensed by a variety of measuring devices and user interfaces. The values, readings, trends and pattern recognition for system 10 may include, without limitation, power use, gas use, water use, video, motion, access, biometrics, HVAC, medicine dose, thermography, man/machine interfaces and call centers. Data gathered may be converted into information relating to activity, health, safety and environmental assurity. This is accomplished by combining the inputs of the portfolio of sensing apparatus with activity models and pattern recognition to score the monitored person's activities and well being. There may be provided decision rules which automatically notify call center personnel, other designated parties and subroutines pending the digital assessments being made against decision criteria. These decision criteria may be learned pattern and experiential based rules. Processes for system 10 may be managed by digital workflow, and the various components of system 10 may be remotely and/or on site adjusted pending the assessments.

Some of the key features of digital assurance system 10 may include, without limitation, the synthesis of multiple sensing systems in order to infer the performance of the home building envelope as well as an occupant's activities, and the ability to improve the human factors associated with entertainment, system interface, and virtual companionship. Building envelope assessments may be made via deterministic rules associated with security, fire, atmosphere, access, monitored apparatus status, etc. Patterns may be assessed and synthesized. For example, gas on and thermography in kitchen and lack of movement for duration may equal the generation of an alert, for which, an appropriate action may include notification to a call center for care giver contact or generating in-home feedback request. Accordingly, the important features for system 10 do not only include the correct sensing mechanisms, but also include the algorithms and infrastructure to assess the environment and an occupant's status. By enabling assessments such as this, mobile or distributed services can be more productive and in-home living may be extended. The fact that the assisted living expense can therefore be reduced has direct bearing on medical claims, long term care insurance and out of pocket expenses associated with care and monitoring. For service providers, quality of care increases while at the same time lowering cost, thus enabling new insurance products which can be priced for a new class of exposures.

The aforementioned features and benefits of digital assurance system 10 will now be described in detail in reference to FIGS. 1-7.

Specifically, referring to FIG. 1, there is disclosed a long term care business system 12 where digital assurance system 10 according to the present invention can be used advantageously. For business system 12, potential clients 14 may be approached and offered insurance in origination process 16. Clients 14 may have the descriptive attributes matching those of targeted clients who would have a propensity to desire the service offering, would respond to being contacted and would be profitable clients based upon the profitability criteria set forth in block 18. These clients have the potential of, but not a requirement for, financial and for security value. Upon contact and response, the potential client may be assessed for severity and time of a potential claim in underwriting process 20. Once the insurance provider has an understanding of the risk, an insurance firm may price policy at block 22 and offer a quotation at block 24. Upon accepting and paying premium for a policy, the potential client may become a client when an order 26 is received. Premiums may be invested at block 28 and accrued for the potential future claim. Servicing at block 30 of ongoing premiums may continue until such time as death, lapse in premium payment or payment of a maximum claim at block 32. The portfolio of liabilities at block 34 may be less than the investments accrued. Should a claim be paid, investment reserves may be utilized. The payment of claims involves large sums of money paid to service providers or policy designees, such as care providers, thus the detection and prevention of fraud at block 36 is also a core process of the firm. The present invention offers benefits to the core processes of servicing at block 30, claims at block 32, fraud detection and prevention at block 36, profitability at block 18, lead generation at block 14, and attracting potential clients with an advantageous insurance product value proposition at block 38.

Examples of these benefits are typical but not restrictive in the exemplary embodiment discussed above.

For example, servicing at block 30 may involve the processes of collecting premiums. A client who maintains belief in the insurance product's value proposition and has an ongoing constructive relationship with the company and has the means to pay for the policy is desirable. Digital assurance may be a service option that would increase the value proposition of the insurance product and thereby increase the propensity of the client to stay current (i.e. not lapse) on the premium.

Once claims at block 32 are made, digital assurance system 10 increases the probability of a lower cost of claim per unit time period and thereby increases the likelihood of increased returns from the net of the investment portfolio and claims which is managed so as to have sufficient assets to pay the forecasted claims. Also upon paying claims, there is benefit derived from the detection of fraud and its prevention at block 36 in FIG. 1. This may be attained by monitoring the contracted services from an administrative workflow all the way through to the in-situ delivery of those services.

Profitability at block 18 may be enhanced by reducing the cumulative severity and/or extending the period of lifecycle claims and by the fact that a more advantageous service is offered thus leading to increased volumes of business. Lead generation at block 14 may become more accurate to the extent that the risk and value attributes of clients become more precise. When seeking new business, the underwriting and pricing can become more accurate as can the targeting of potential clients based upon those attributes. Finally, the advantageous insurance product value proposition at block 38 of remaining in-home potentially longer than otherwise or buying a policy that would have as its claim, the digital assurance product and service offering, is of great value.

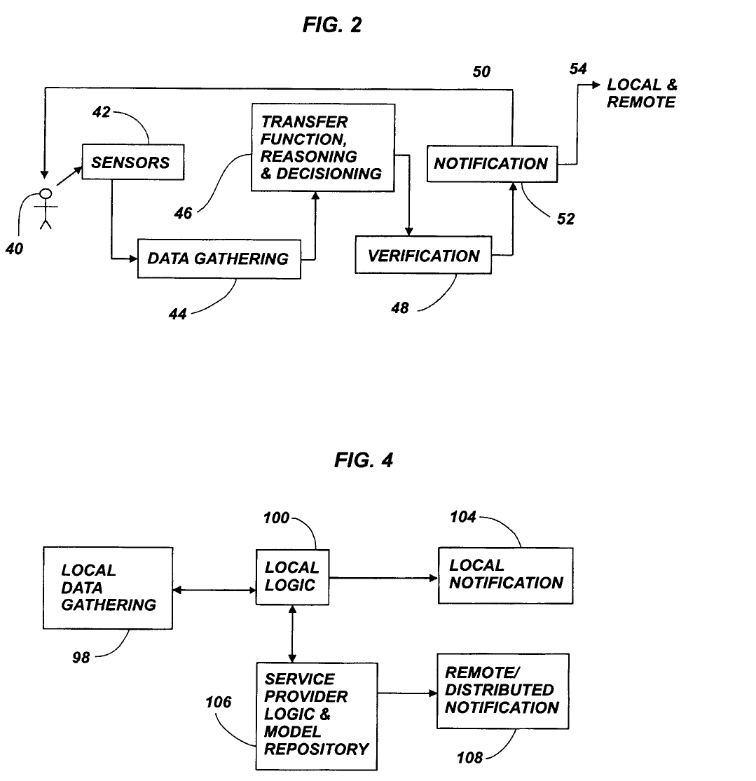

Referring next to FIG. 2, digital assurance system 10 may generally include seven subsystems, having the logic flow block diagrams illustrated in FIG. 2. As shown, occupant or recipient 40 of monitored assurance may utilize time, space and resources in pursuit of living within the control volume being monitored and controlled. The notion of a “control volume” is used herein with a similar intent as is made in the engineering arts. This control volume may be a fixed well-defined boundary such as a home, a room in a healthcare facility, a place of business, a public space etc. The control volume may also be a flexible, dynamic, reconfigurable, adaptive space with dynamic boundaries of time, activities, resources and volume. For the exemplary in-home application of the present invention discussed herein, the control volume may be an area defined by the boundaries of a living room, dining room and kitchen, or may further include bedrooms and/or windows and doors of a home setting.

Sensors and sensed systems 42 may include all means that information is actively or passively attained. These devices may be discrete such as contact, motion, temperature, flow, RF tagging, biometrical, user I/O devices, data extracts from affiliated processes and services such as phone, cable, service providers, and stand alone or networked electronic and/or appliances and devices. For the exemplary in-home application of the present invention discussed herein, a variety of the aforementioned sensors may be employed to the control volume for the assessment of an individual's status, health and safety as required. Data gathering systems 44 may include signal conditioning, data pre-processing, workflow, data interfacing and the communications network itself. Storage of this relevant data may be written to local or remote data repositories, random access memory or any other storage media. One key element is that structured data is available for the reasoning, inferencing and decisioning transfer functions and logic at block 46. The computations made in block 46 are in themselves a major subsystem of digital assurance system 10.

Verification at block 48 may be made of data and inferences drawn from monitored occupant and resource activity in order to lower false positive decisioning. A plurality of active sensor and sensed systems proactive data requests may be requested, subsequently monitored and tested with validating logic. The decisioning and validation logic may be typically probabilistic in nature. Existing art, for example, has a rule that if a window contact is opened when an intrusion alarm is desired, an alarm is enabled. An open contact may generate an alarm for all instances of activity. This is contrasted with inferred activity and verification of the condition state. For the exemplary in-home application of the present invention discussed herein, an example would be if gas flow is greater than a threshold, furnace off, water heater off, kitchen motion, kitchen sound, other control volume sound is less than an adaptive threshold, time of day, and appliance settings, taken together, would infer that the occupant is cooking in the kitchen. There can however not be 100% certainty if motion is also detected elsewhere. Activities and inferences have degrees of risk. Additionally, for the exemplary in-home application of the present invention discussed herein, smoke detection plus RFID may infer that the occupant is not responding to a fire alarm. Again, there may be less than 100% certainty that the occupant has the tagged item on their person, but assignable probabilities of suspicion that they do is enough to trigger a chain of events and priority notification of others. This would be in contrast to a window contact being open with motion detected at a time when the occupant is typically home with 75° F. exterior temperature; verification would therefore be desirable before determining if an intruder has opened the window because it would be within reason that the window would be opened by the occupant. Verification request 50 could include motion in just one sub volume, appliance activity, rate of state change variables, a keypad request and the like. Notification at block 52 may then be made once the risk-weighted probabilities of a false positive are acceptable. Notification may be local and/or remote at block 54 and/or posted to a monitoring data infrastructure.

Data derived from the activities of life may be used to infer the robustness, integrity and quality of life for the purposes of enhancing the quality of living in situations where individuals may have impairments that otherwise might cause their stakeholders or themselves to decide that a move to a more managed care venue is needed. Thus, data may be attained where structured mathematical calculation of transfer functions can take place to derive the activity and person's interface with that activity in the context of living in that control volume. These data are desired to be passively and discretely attained since individuals are typically desirous to maintain their dignity and autonomy. For the exemplary in-home application of the present invention discussed herein, an example of data that is not well received is, at this time, in the culture typical of the United States, video surveillance. Examples of ubiquitous but inoffensive data include that typically associated with intrusion security, fire, utilities, appliances and the like; data from systems that serve a primary purpose other than monitoring activity. The disclosed digital assurance system 10 seeks to repurpose as much of this type of data and infrastructure as possible in order to deal with the human element. Where such passive data can not be attained or where sufficient accuracy of inference can not be attained, then there is a need for other sensors and systems. Both of these types of data sources are included in the disclosed method and system for digital assurance.

There are numerous examples of how discrete and combinatorial data can be utilized to ascertain the activities and health of the person(s) being monitored. These cited examples are illustrative of the concept and are not limiting. All cases, evidential combinations, rules and simulations that will be discussed herein may be configurable and adaptable for the purposes of continuously learning about activity and enhancing the inferences made by digital assurance system 10 and its associated method.

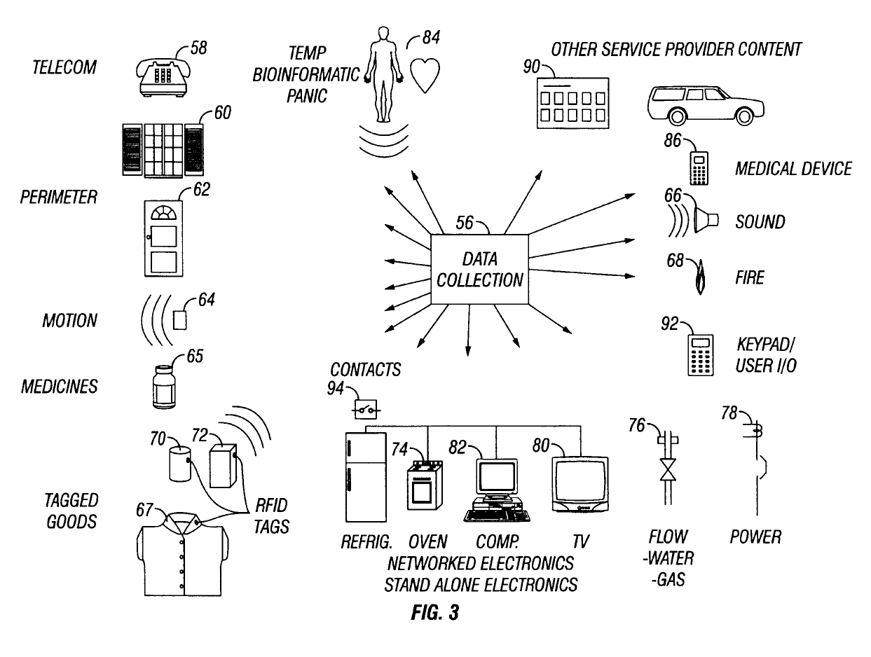

Referring to FIG. 3, there are illustrated sources of data in an exemplary embodiment of the home. Communication to/from data collection device(s) 56, 44 can be RF, wired, superimposed onto power circuits, cellular phone, internet, networked and the like. One key element is that the sensor or subsystem may be connected to a data gathering mechanism.

An example of how data accumulates for inferring the health state (mental and/or physical) is telecommunications 58 which enables much insight to the activities of individuals. For the exemplary in-home application of the present invention discussed herein, examples include time of day for an activity, location of activity, for certain counterparties the very nature of the call can be ascertained, length of calls, length of calls per specific counterparties, frequency of calls, frequency to certain counterparties, the administrative status of keeping account(s) current with bill activity, the ratio of inbound and outbound communication, all of the above plus any or all other information derived elsewhere or rates of observed change, all of this data is germane and included in the disclosure herein.

The control volume term may refer to the time and space of interest that is relevant to inferring activity and appropriateness of activity for the purposes of digital assurance applications. In the home context, for example, the control volume might be similar to that of perimeter security. It would be reasonable to expect that house-bound individual(s) would perform their living activities within the interior four walls of the home. RFID tags, sound and motion detection and door openings inconsistent with that might be evidence of an anomaly that care stakeholders should be aware of.

Sensors associated with alarm systems such as windows 60, doors 62, motion 64, sound 66, fire, smoke, CO 68 provide data that may be relevant in whole, in part or in combination with other data about living activity. For the exemplary in-home application of the present invention discussed herein, a window opening in a zone where there is no interior motion or where biometric transducer signals are not being picked up or are inconsistent with the positioning data of RFID tags may be an anomaly with a propensity for an intrusion inference. If the same opening occurred where the location of the individual matched that window and/or the rate of change in location was consistent with the person having the probability of being in that position, then the inference would be one of a validated activity. Since motion, doors, sound all work in similar fashion, the patterns of activity can be inferred from the location, time, differencing enabled by these types of sensor systems.

Devices 65 such as weight and volume sensors, tags, contact, lasers used to measure, dispense and monitor stocks such as medicines, food stuffs, laundry and the like are also germane to inferring activity. Rates of consumption, changes in rates of consumption and inventory balance reconciliation are separately and in combination with other data, useful. For the exemplary in-home application of the present invention discussed herein, an example would be medicine consumption at a certain time window, medicine consumption in combination with a biometrical sensor, food consumption and appliance use, food consumption and food replenishment balances all enable the detection of anomalies related to quality of life a home bound individual.

RFID tags on clothes 67, linens, food stuffs 70, books, personal items 72, apparatus and the like may be used to obtain location and status from those devices separately or with other data. These tags may also be used for location of items that can be misplaced and thus would be a source of frustration for an individual if lost, misplaced or stolen. The status of laundry, food stores, food consumption, clothing, location, and medical equipment may be enabled.

For the present invention, appliance use is core to inferring the status of living activity. For example, stove 74 being used in combination with motion and volume in the kitchen (but not in the bedroom) at a certain time of the day would be a desirable activity. For the exemplary in-home application of the present invention discussed herein, stove 74 being left on with no movement for a given period of time as being sensed by security motion detection and utility flow rates 76, 78 and contacts 94 on the appliances or networked appliance communication at location 98, would be an anomaly that is dangerous and deserving of immediate validation and notification or control intervention.

Activities associated with devices typical to relevant daily activity such as, for example, TV 80, radio, computers 82, exercise equipment, medical equipment and the like are also of interest as they too can be used to infer activity states. Biomedical arts and technology 84 are rapidly changing, and require on-patient, real time monitoring of, for example, vital signs, blood oxygen and sugar or enzyme levels, levels of medicines and compounds in the blood stream and the like for inferring the health state of the monitored persons. Thus, an elevated heartbeat by itself may be cause for alarm. The heart beat in combination with location that indicates stair use however may not be as critical. The rate of decay of heart beat frequency per unit time after using the stair might be very insightful to a medical professional. The automated tracking of this rate of change over a period of time would be a feature of the disclosed invention. The consumption of medicines and the metabolic changes would be of interest and would also be monitored activity that is germane to the present invention.

Medical devices 86 such as oxygen dispensers, IV dispensers, various monitors and apparatus are also germane in a similar way as biomedical devices 84 but also with the benefit that these devices may be monitored for functionality, inventory, utilization, servicing and condition. Utility use such as the flow rates of water, gases 76 and power 78 aid in understanding of the activities within the control volume. Gas rates inconsistent with that of water heating, outside temperature, time of day, HVAC and cooking may be of interest to a care-giving stakeholder.

For the present invention, data gathering is not limited to that from sensor and networked apparatus. Other service providers may have administrative workflow and tracking systems 90 that enhance the quality of life picture. Examples include service providers (by contract to service the claim or by hire to take care or provide services desired) such as mobile meals, traveling nurses, church affiliations, hospice organizations, medical device, laundry service, repairs, utilities etc. The in-home consumption of services should match the billing and dispatch records and care plans. Changes in rates of billing, frequency of service, inventory balance mismatch and the like are all value added features of digital assurance system 10.

Client feedback and validation of certain inferences is needed. A user I/O device 92 may serve as a system status portal for service providers as well as a means to ask the monitored person specific data requests. I/O device 92 may also serve as a communications mechanism from the occupant to the digital assurance service provider. The device may be fixed or movable or embedded in other apparatus. As will be discussed in more detail below, if an inference is made from passive deduction that indicates risk, a validation feedback loop may be activated. An example would be the cooking in the kitchen scenario previously discussed: no movement, gas flow and an extended time span. The inference may be that the stove was left on and the person has fallen asleep. This is a condition state that is not desirable because of the implications on fire, health state and cost. In such a case, user I/O device 92 would be signaled by the validation logic within digital assurance. I/O device 92 may make an audio-visual request for data to the occupant. For the exemplary in-home application of the present invention discussed herein, if the occupant acknowledges the request, the situation may be lowered in its risk scale but perhaps a caregiver may be signaled to find out why the stove was on so long. The follow-on conversation would be incorporated into a scheduled call or queued up to the next or specific stakeholder so as to both appear natural to the client and be promptly tracked. The workflow logic and feedback mechanism are integral to digital assurance.

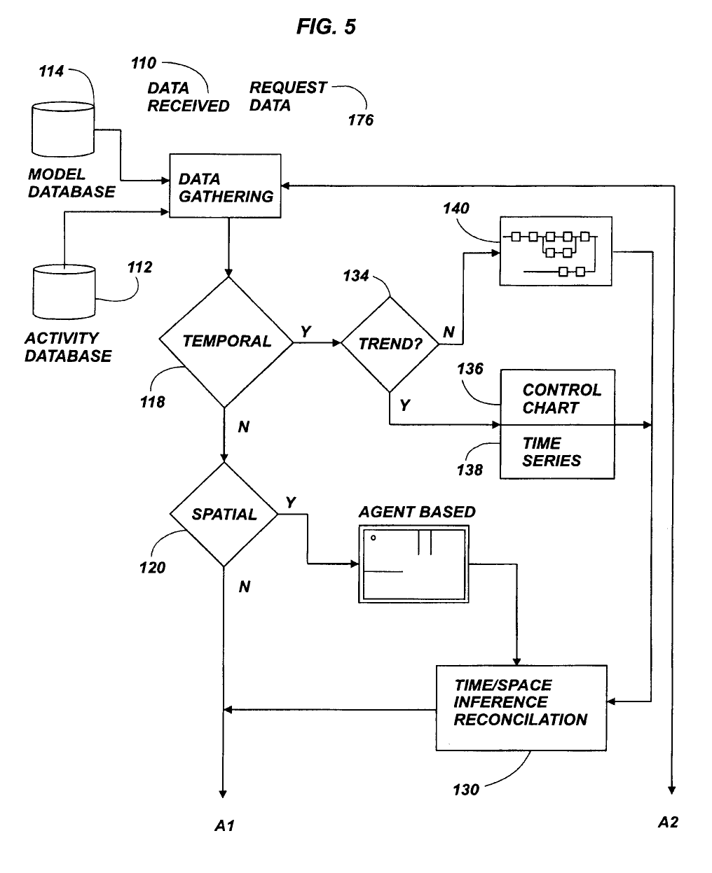

As shown in FIG. 4, digital assurance system 10 may seek, collect and organize data, then perform logic and calculations before notification of stakeholders involved in the care or security. For FIG. 4, local data may be collected from, among other sources, the sensors and systems depicted in FIG. 3. The totality of collected local data is represented by “Local Data Gathering” at block 98. The term “Local” should be interpreted as locations of sensor data that are within the physical spaces or premesis being monitored, regardless of where these spaces may be. The data being collected is local to the sensors and it may or may not be where the full portfolio of logic or algorithms is. The sensors may or may not be located in contiguous physical locations.

Local logic 100 may include routing, calculations and decisioning. The microprocessors associated with local logic 100 may reside where the cost of a consolidation point is less than the cost of wiring or limits to RF. Software within local logic 100 processors may be hard coded for the life of the system or circuit board or detachable memory device, may be field reconfigurable, or may be remotely configurable over a networked connection 102. Local logic 100 may perform sensor communications, data consolidation, remote communication, primary or backup command and control.

Local Notification 104 may include alarming, other supported system interfaces (such as, for example, utilities such as power, gas, water, oil systems, and appliances such as hot water heater, furnace, stove), and user input/output devices such as a keypad, computer, TV, voice recognition.

Digital assurance system 10 may be operable on a single unit basis. This configuration may include a centralized processor that would also serve content to those with access. An embodiment of digital assurance system 10 is that of a centralized service provider with connection to many monitored persons. In this way, the scale of integrating other stakeholders may be economically advantageous to support the system development costs and continuous feature enhancement and promulgation. Additionally, increasingly more accurate models and decisioning may be attained from the multiple generations of information and decisioning technology.

Service provider logic and model repository 106 associated with the centralized service embodiment may include the data against which new models are developed, the master decisioning models which can be called for each monitored space or person, process workflows, algorithm quality monitoring, and activity data of record. The decisioning models may include those associated with the digital assurance of space or people as well as the administrative decisioning associated with stakeholders.

Remote and distributed notification 108 may include other integrated stakeholders. For the exemplary in-home application of the present invention discussed herein, examples of these stakeholders may be security, health care workers, family, friends, and other service providers.

One key advantage of digital assurance system 10 is in the relationship between local and remote distributed decisioning. A prodigious amount of data acquired centrally, over time and over multiple venues may be leveraged to build more precise inferencing algorithms. The activities and decisioning from a plurality of users forms a knowledge repository for generalized algorithm and product/service development. Technologies that may be leveraged to build these algorithms may include those associated with Artificial Intelligence, Neural Nets, Agents Simulation, Case Based Reasoning, Evidential Reasoning, Data Mining, Rule Base Decisioning and Fuzzy Logic Reasoning. Pattern attributes local to the sensed spaces or persons which are collated from local sensors, stakeholders and history may be used for decisioning inputs. Where the calculations take place are transparent to the users. The principal deployment is central and thereafter, once validated, the local microprocessor(s) may be updated.

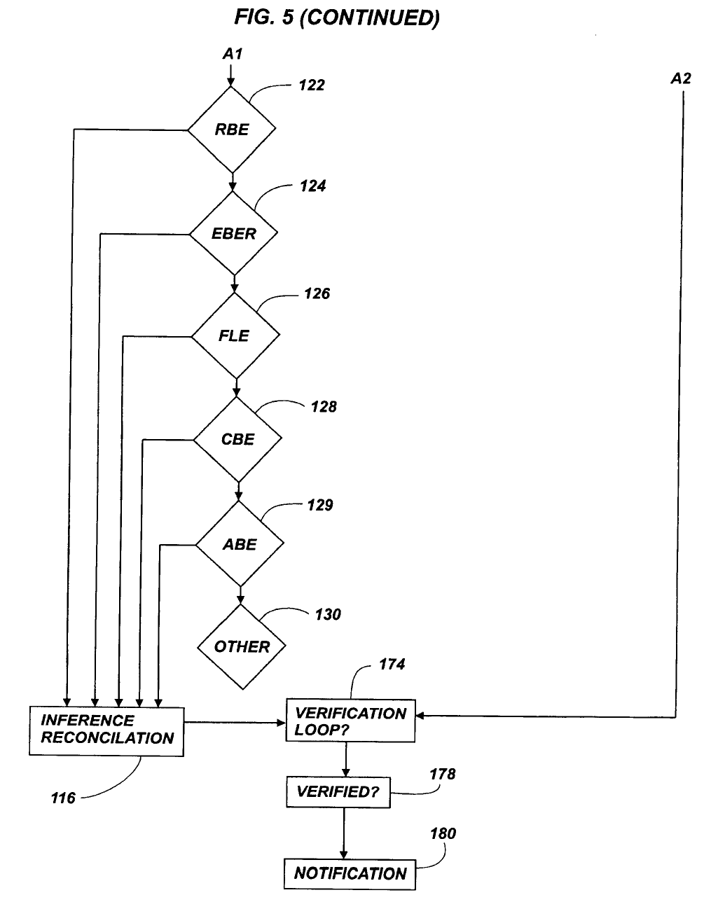

Whether remote at block 106 or local to the sensed spaces at block 100, the method used to convert sensor data into an activity inference is outlined in FIG. 5. Specifically, referring to FIGS. 4 and 5, data may be passively or proactively attained. Passive data may be gathered at a set time interval and/or as a sensor state change is sensed. This data may then be collated locally at block 98 and acted upon based upon the prescribed logic code. Proactive data is that which results from logic or calculation requests, as is the case with validation runs or timed data sweeps. A validation run is that data and algorithm which is used to ascertain an acceptable profitability of an activity inference. Timed data sweeps are scheduled gathering of data based upon clock time. In either case, data may first be gathered. The start of the algorithm logic begins when the gathered data is received at block 110. Should specific data not be present, for example, should a sensor fail, the logic would enable diminished decisioning, but not crash the system.

Sensor and related stakeholder data 110 may be augmented by historical activity data at block 112 that may remain local, or be called remote or from an historical central archive. Activity model algorithms that are stored in a model database 114 and called by system logic residing in local or remote processors 100 and 106 may process these current and historical data.

Digital assurance may seek to infer activity at block 116 as a function of time at block 118, of space at block 120, of specific observation fact patterns at block 122 and of relative fact patterns one to another at blocks 124, 126 and 128. The appropriate models, if not in processor random access memory at the time of need, may be called from model database 114 when data is received at block 110.

Temporal inferencing at block 118 is probabilistic reasoning of activity as a function of time. An example would be motion in a physical volume. For the exemplary in-home application of the present invention discussed herein, as a person walks, a rate of speed is sensed from position sensors as a function of time. Additionally, given a certain rate of speed and the physical place of the motion, an inference may be made as to the probable position of the person at an interval of future time. For the exemplary in-home application of the present invention discussed herein, an example would be a stairway where it is known that a person enters the stairway and then what the rate of climb is from subsequent positional data points. Based upon the rate of travel and rate of change of travel speed, a probable inference may be calculated as to when the person should finish climbing the stairs.

Temporal reasoning however may or may not be germane to an activity. Where there is activity sensed in a geographically fenced volume associated with the monitored entity and an unrelated activity is sensed, the need to infer temporal reasoning beyond the inconsistency of the activity patterns is diminished. For the exemplary in-home application of the present invention discussed herein, an example would be a person sleeping in a first location and a detection of smoke in a second location. Where there is monitored entity motion sensed, inferencing of activity may be enhanced with temporal reasoning. In this illustrative example, it is sufficient to alarm the anomaly of smoke in a location and a person who is likely to be sleeping in the bedroom. It is more desirable in the context of the disclosed home assurance system to alarm per the current art and now know that the person has heard the alarm and in fact have exited.

Where an activity or state is forecasted to be is highly dependent on where the activity(s) occur or should occur—spatial reasoning at block 120 is nearly always present when the time domain is considered. An example of implicit spatial consideration may be seen from the stair example above. Temporal reasoning does not care if the activity is a stair climb, only that based upon a rate and a rate of change of rate, what the future rate and position (and potentially biometric results) will be. Spatial reasoning logic may be configured to ignore if the activity is proceeding slow or fast, only that the activity is occurring where it should. Alternatively, spatial reasoning, applied to the inference of physical condition, might be configured to assess specifically that activity is occurring at the rate and place it is predicted or logically supposed to occur and take a decision. It is the combination of space and time and what other metrics are at block 130 that the inference of good/bad, normal/abnormal can be made of the activity in process. Because of this interdependency of time, space and resources consumed in time and space, the digital assurance inferencing at location 132 will be described concurrently.

Pursuing the temporal path at block 118, the need for time based reasoning may be affirmed by activity associated with the person(s) or entity being monitored, where activity is being ascribed by location and resource state. Motion may be resolved into trend at block 134 by deriving the change in position as a function of time. If the rate of change of position and the rate of change of speed are linear, a trend may be inferred. A rate and a position may be within upper and lower control limits, as derived by those familiar with statistical process control would calculate for the purpose of control charting at block 136. The expected value would fall between statistical limits with a certain confidence. Exceeding the confidence bounds would infer a non-linearity or anomaly that other logic would reconcile. A time series forecast at block 138 would also be enabled with data sets that are predominantly linear or if not linear, have the non-linear aspects occurring in predictable time intervals.

The vast majority of activity may not be trended such that the activity duration may be random, short and interdependent on another context. Exceptions to this may include, for example, sleeping length and time of day, cooking/eating time of day, medication time of day, aggregated activity density over time and by season, and care duration and time of day.

In the disclosed method and system for digital assurance, discrete event simulation technology may be utilized to reason in the time-space-activity continuum at block 140. Discrete event simulation is a mature analytical art which has been highly developed in the industrial and management sciences for process research where the consumption and utilization of assets, resources, activities and entities over a period of time is of interest. Its application to digital assurance system 10 is as a forecasting tool to reconcile the logical interdependencies and variances associated with activities appropriate for the venue being monitored.

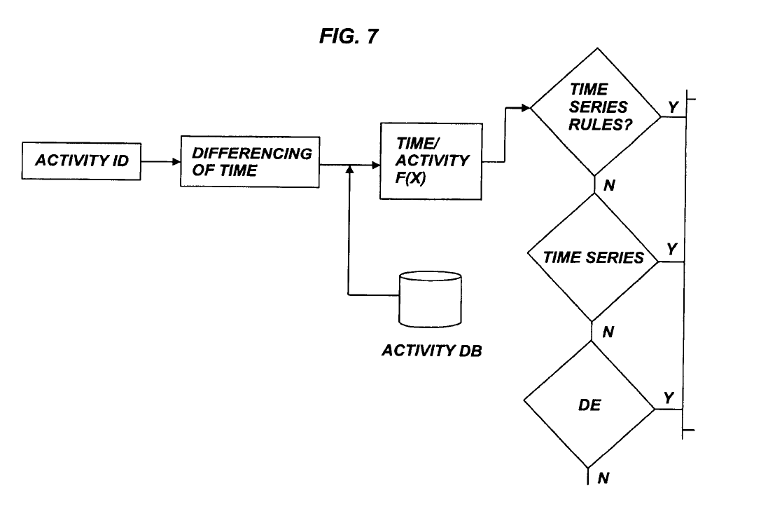

Referring next to FIGS. 5 and 7, there is disclosed the logic of applying time differencing, control chart, time series and discrete event. Examples of reasoning enabled with discrete event simulation transfer functions may include most major activity states. On a daily basis, as an example, a person experiences a sleep cycle, morning, noon and evening meal and medicines, and perhaps scheduled physical activity or healthcare assistance. The daily cycle is a series of parallel and serial activities with interdependencies (i.e. food requires raw materials from a pantry or refrigerator and an appliance and power and utensils and cooking activity). For the exemplary in-home application of the present invention discussed herein, when cooking, one can not also sleep or remain out of the kitchen control volume for a certain time period or pattern. Discrete event or Agent based model(s) at block 140 may be used to derive and monitor the ranges and logic of expected activity. Anomalous consumption and utilization of resources, which include assets, persons, time and raw materials are alarmed. Discrete event or Agent models may also be utilized to forecast time and state given other activities in series or on parallel path. Technologists skilled in the art would be capable of deriving the activity transfer functions. Technology developed in the healthcare and business process workflow domains to derive simulation transfer functions may also be fully applicable and leveraged in the digital assurance methods and system of the present invention.

Spatial reasoning may be applicable when location is germane to the activity state or wellness or appropriateness inference. The decision to perform spatial reasoning at block 120 may be accomplished by the rule-set triggered for either proactive activity monitoring or by activity triggers. Examples from both categories may include the following. Proactive: sleeping may be forecasted to occur in a time and space continuum based upon desired and normal activity. Spatial reasoning may be required for this activity assessment. Activity trigger: motion may be sensed thus triggering an activity inference routine. For the exemplary in-home application of the present invention discussed herein, an example would be the stairs situation described above. Pieces of activity evidence are accumulated to enhance the confidence of the inference of activity and assessment of its suitability.

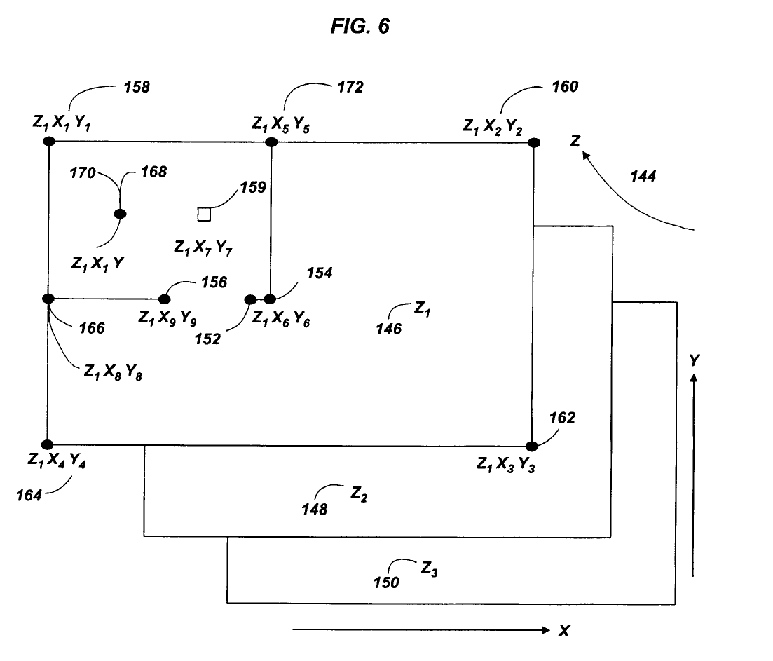

Agent based simulation with a novel dynamic control volume technique at block 142 may be utilized to derive spatial (and temporal) inferencing, as disclosed in FIG. 6. Specifically referring to FIG. 6, four elements are disclosed: dynamically configured spatial/volumetric simulation space; activity density, sequence and rate; spatial rate; and activity-resource reconciliation.

Considering a home, as an example of a control volume with defined outer boundaries, the spatial reasoning method is disclosed. The volume may be separated into three layers depicted as the “z” axis 144 that are analogous to basement, main and upper floors. Any meaningful volume boundary wherein other vectors are needed to describe location—for example, a floor excludes location in any other plane for concurrent values of x and y (corresponding to width and length of a floor space). Within each floor are physical limits and areas of interest because of the activities performed and typically performed at specific locations. A physical area may also be of interest because of physical constraints on activities, for example a wall separating a living room from a kitchen. The person(s) 168 being monitored may be the “agent(s)” in the model. The agent 168 may exist in mutually exclusive time and space continuums.

Using Z1 at 146 as one of the three levels, the others being Z2 at 148 and Z3 at 150, geographical constraints 152, 154 and 156 may be added to the control volume bounded by the perimeter 158, 160, 162 and 164. ZXY coordinates may be expressed as a function of distance relative to a reference point. For example, house corner 164 could be z=1, x=0′, y=0′. Wall illustrated as 156 to 166 would be 1(Z), 0(X), 15(Y) 166 to 1(Z),8(X), 15(Y) 156. It would therefore be logically inconsistent that a person (agent in the model environment) 168 would travel from ZXY at 170 without passing through the door opening created between 152 and 156. Further, for example, defined activity at 170 would require the presence of agent 168 for some period of time at location 170.

For the exemplary in-home application of the present invention discussed herein, a logical expression for cooking with the oven, would then include data to establish the agent 168 and location 170, oven location and manual power on at location 170, sound signature, noted change in house current or gas flow, lack of activity elsewhere in the house. At a time to, pantry contact and refrigerator contact or networked result would exist. At time t+300 minutes, an expectation of oven gas or power off, water usage cycled and activity elsewhere in the house. Differences from these infinitely adjustable settings and probabilistic ranges may be tagged as anomalies.

For the exemplary in-home application of the present invention discussed herein, an example of time-space inferencing would be the stair activity described above, where agent 168 may be tracked through the space on Z1 from location 170 to 146. At the stairs from Z1 to Z2 at 148, a time and space snapshot of activity may be taken and temporal-spatial reasoning may be initiated for an activity “stairs Z1-Z2”. At time t+n, location change may be recorded. At time t+n2, location may also be recorded. Rate and rate of change of rate may be calculated and sent to the simulation activity “stairs” for which a comparison is made between actual and expected duration. Concurrently, sensor systems validating motion and sound are consistent with past stair activity. For FIG. 3, biometrics data at 84 may indicate increased heart rate. This would not be an anomaly since the biometrics trend change was consistent with the time and physical activity of stair climbing for this reason and a characteristic probability typical for a person such as this and/or a specific person. Rate and rate of change of biometrics patterns before, during and after the climb may be of interest to healthcare workers especially over a period of many stair climbs and weeks/months. The illustration is not to call out unique logic, but to illustrate the combination of activities, time, location, and ancillary measurements to cross validate activity, health and long term trends in each.

Returning to FIG. 5, after time-space inferencing is initiated, a series of rule engines may be applied. These progress from structured if-then-else logic executed in the rule based engine (RBE) at block 122 to the evidential reasoning engine (EBER) at block 124 that enables an inference in the face of unclear or incomplete or contingent data. The fuzzy logic engine (FLE) at block 126 may derive inferences in the face of ambiguous data where the data values reside at the edges of hard rule cut-offs. The case based engine (CBE) at block 128 may match historical learned patterns with the current pattern set and ascribe the current condition to the best fitting historical disposition. The agent based engine (ABE) at block 129 may match against historical or population patterns. Other stake holders, analysts, engineers 130 working on alternative decisioning mechanisms or alternative algorithms may perform other observations, inferences or decisions. These are examples of a hierarchy of decisioning engines progressing from most rigid to most global in comprehension. The inference reconciliation at block 116 may be made by additional algorithms such as simple rules to “most-weighted-votes-wins” to vote patterns or any number of rationalization methods.

False positive inferences are undesirable because of nuisance notifications which upset the person being monitored in the home example, cost is driven up for stakeholder activity and trust is lost by the monitored and others, for example, who desire to extend better care at lower levels of person to person contact. Some combinations of data lead to inferences that must be acted upon immediately regardless. For the exemplary in-home application of the present invention discussed herein, for example, smoke being sensed would lead to an alarm, even if it were also known that the oven has been on and the door was opened within the last two minutes. Some inferences should be validated with more data collection or even direct feedback from the monitored individual(s). This inference re-check is the Verification Loop at block 174.

The verification loop is activated to learn more about the fact patterns associated with activities. If the inferred situation is not life threatening in isolation and to reduce false positives, additional monitoring may be made. A request at 176 for more sensor data may be made to the data collection mechanisms. For the exemplary in-home application of the present invention discussed herein, illustrative examples include service provider schedules check when front door is opened, sound level checks when motion is not sensed or in the most extreme cases a request for keypad or voice feedback to ensure the person is OK or for a learning data point for future fact pattern inferencing. Upon verification at block 178, notification at block 180 of the inference may be made as appropriate.

Digital assurance system 10 thus uses an integrated portfolio of sensing systems, call center, process algorithms and internet communications to eliminate many of the reasons people need to leave the comfort and safety of their homes for assisted care. Similarly, people in institutional care can be monitored and more comprehensively cared for. System 10 further enhances the quality of life for persons in their home, where value beyond enjoyment of the home is derived from reduced medical care and assisted living expense for government agencies, insurance and families.

System 10 thus provides the sensing technology and processing systems to extend the time folks can stay in their homes, lowers costs and error rates for the same level of monitoring in institutional settings, enables Long Term Care insurance products and services by having the ability to detect activity and notify assistance when needed, and lowers risk in general for lower insurance and reinsurance rates.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

1. A system for facilitating living in a predetermined location for an individual, said system comprising:
an integrated portfolio of at least one of active and passive sensors for monitoring activities of the individual;
an analyzing system for synthesizing and analyzing signals from said sensors for thereby assessing a status of the individual and inferring the individual's at least one of state, status and quality of life;
a decision making system for generating an output based upon said assessment; and
an activation system for one of validation and activating processes to respond to said output from said decision making system.

2. The system according to claim 1, wherein said sensors are capable of sensing at least one of contact, sound, vibration, temperature, humidity, video, motion, access, location, telecommunications, computer traffic, HVAC, power, flow of utility services, appliance status, thermography, biometric monitoring and man/machine interfaces.

3. The system according to claim 1, wherein said sensors monitor usage of at least one of appliance, Hi-Fi, alarm, television, radio, computer, exercise equipment and medical equipment for assessment of at least one of health, activity and safety of the individual.

4. The system according to claim 1, wherein said analyzing system comprises at least one of algorithms, rules engines, decision making systems and workflow to convert raw data from said sensors into probabilistic assessment of at least one of health, activity and safety of the individual.

5. The system according to claim 1, wherein said analyzing system utilizes at least one of Artificial Intelligence, Case Based Reasoning, Evidential Reasoning, Data Mining, Rule Base Decisioning, Fuzzy Logic, Agent Based, System Dynamic, Discrete Event and Monte Carlo Simulation in its reasoning.

6. The system according to claim 1, wherein said analyzing system utilizes data from at least two of said sensors for assessing the status of the individual and inferring the individual's at least one of quality of life, status, condition, security and health state.

7. The system according to claim 6, wherein said assessment of status is used to probabilistically or deterministically determine if an activity is normal or an anomaly, such that if said activity is normal as defined by a probability set-point, then said decision making and activation systems label said activity as normal, but if said activity is an anomaly, said decision making and activation systems perform at least one of contacting the individual and sending assistance to the individual.

8. The system according to claim 1, wherein said system is integrated with at least one of a health and owner's insurance to at least one of reduce a cost of said insurance and enhance care at a given level of said insurance, the owner being one of a home owner, an institution and an insurance company with or without reinsurance.

9. The system according to claim 8, wherein said insurance includes at least one of a reduction in premium and increase in coverage for extension of in-home living by means of said system.

10. The system according to claim 1, wherein said system facilitates living in at least one of a home of the individual, a hospital, an assisted care facility and an institution.

11. The system according to claim 1, wherein said analyzing system comprises at least one of a computer and a call center, located at a remote location from said predetermined location, for analyzing signals from said sensors.

12. The system according to claim 1, wherein said decision making system generates said output based upon said assessment of values, readings, trends, and pattern recognition from data related to at least one of power use, gas use, water use, video, motion, access, biometrics, HVAC, medicine dose, thermography, man/machine interfaces, computing platforms and call centers.

13. The system according to claim 1, wherein said sensors comprise at least one of automated voice, touch and home physical system input/output sensors.

14. The system according to claim 1, wherein said system further comprises means for generating at least one of a voice or electronically instantiated query, sound, optical, motion and a vibration signal to the individual upon the detection of an anomalous pattern of activity.

15. The system according to claim 14, wherein said means for generating is integrated in at least one of a medical device, a device with a processor, a TV, radio, telephone, user I/O device, appliance interlock and physical device interlock.

16. The system according to claim 1, wherein said processes being adjusted comprise at least one of remote and on site adjustment.

17. The system according to claim 1, further comprising a verification system for verifying said output by said decision making system for reducing the chance of a false decision.

18. The system according to claim 1, wherein said system utilizes at least one of a dynamically configured spatial/volumetric simulation space, activity density, sequence and rate, spatial rate variation and activity-resource reconciliation for assessment of at least one of health, activity and safety of the individual based upon at least one of spatial and temporal inferencing.

19. The system according to claim 1, wherein said system includes at least one of logical and reasoned rules for comparing a volumetric and temporal dynamic control volume for persons and activities of the individual.

20. The system according to claim 1, wherein said system includes a plurality of sensors for enabling reasoned inputs and validating reasoning results.

21. The system according to claim 1, wherein said decision making system utilizes at least one of RF and mobile tracking means for assessing the individual's quality of health.

22. The system according to claim 1, wherein said system utilizes appliance and utility use or flows to reason on at least one of health, activity, safety and status of at least one of the individual and the individual's environment.

23. The system according to claim 1, wherein said system utilizes Agent Based Modeling to reconcile at least one of time and space appropriateness in activity and status of at least one of the individual and the individual's environment.

24. The system according to claim 1, wherein said system utilizes mutually exclusive time and space continuums to at least one of reason and infer at least one of health and quality of life of the individual.

25. The system according to claim 1, wherein said system utilizes a plurality of sensors for obtaining time and space logical inputs and outputs for inferring at least one of health, status and quality of life of the individual.

26. The system according to claim 1, wherein said system comprises at least one of automated and manual algorithm learning with training motions and activities to instantiate logic and data baselines.

27. The system according to claim 1, wherein said system comprises continuous learning from at least one of activity, sensed signals, reasoning and feedback for increasing reasoning accuracy.

28. The system according to claim 1, wherein said system comprises product offerings that lower insurance and reinsurance cost for at least one of a given service and risk level.

29. The system according to claim 1, wherein said system comprises means for utilization of more global data in comparative algorithms to assess at least one of attributes and context, the comparative wellness and activity state of one who is monitored.

30. The system according to claim 1, wherein said system comprises means for location of items tagged by RF based upon an automated command to locate and display.

31. The system according to claim 1, wherein said system comprises means for checking activities against forecasted or scheduled activities in assessing at least one of fraud, compliance to contracted terms and conditions, an anomaly and an adequacy of care.

32. A decision making system for assessing signals from a plurality of sensors and generating a selective output from a plurality of potential outputs based upon said assessment, said sensors being at least one of active and passive sensors, said system comprising:
an integrated portfolio of said sensors for monitoring activities of an individual in a predetermined location;
an analyzing system for synthesizing and analyzing signals from said sensors for thereby assessing a status of the individual and inferring the individual's at least one of state, status and quality of life; and
an activation system for one of validation and activating processes to respond to said selective output from said decision making system,
wherein said decision making system facilitates living in the predetermined location for the individual.

33. The decision making system according to claim 32, wherein said sensors are capable of sensing at least one of contact, sound, vibration, temperature, humidity, video, motion, access, location, telecommunications, computer traffic, HVAC, power, flow of utility services, appliance status, thermography, biometric monitoring and man/machine interfaces.

34. The decision making system according to claim 32, wherein said sensors monitor usage of at least one of a medical device, television, radio, computer, exercise equipment and medical equipment for assessment of at least one of health, activity and safety of the individual.

35. The decision making system according to claim 32, wherein said analyzing system comprises at least one of algorithms, rules engines and workflow to convert raw data from said sensors into probabilistic assessment of at least one of health, activity and safety of the individual.

36. The decision making system according to claim 32, wherein said analyzing system utilizes at least one of Artificial Intelligence, Case Based Reasoning, Evidential Reasoning, Data Mining, Rule Base Decisioning, Fuzzy Logic, Agent Based, System Dynamic, Discrete Event and Monte Carlo Simulation in its reasoning.

37. The decision making system according to claim 32, wherein said analyzing system utilizes data from at least two of said sensors for assessing the status of the individual and inferring the individual's at least one of quality of life, status, activity, condition, security and health state.

38. The decision making system according to claim 37, wherein said assessment of status is used to probabilistically or deterministically determine if an activity is normal or an anomaly, such that if said activity is normal as defined by a probability set-point, then said decision making and activation systems label said activity as normal, but if said activity is an anomaly, said decision making and activation systems perform at least one of contacting the individual and sending assistance to the individual.

39. The decision making system according to claim 32, wherein said decision making system is integrated with at least one of a health and owner's insurance to at least one of reduce a cost of said insurance and enhance care at a given level of said insurance, the owner being one of a home owner, an institution and an insurance company with or without reinsurance.

40. The decision making system according to claim 39, wherein said insurance includes at least one of a reduction in premium and increase in coverage for extension of in-home living by means of said system.

41. The decision making system according to claim 32, wherein said decision making system facilitates living in at least one of a home of the individual, a hospital, an assisted care facility and an institution.

42. The decision making system according to claim 32, wherein said analyzing system comprises at least one of a computer and a call center, located at a remote location from said predetermined location, for analyzing signals from said sensors.

43. The decision making system according to claim 32, wherein said decision making system generates said output based upon said assessment of values, readings, trends, and pattern recognition from data related to at least one of power use, gas use, water use, video, motion, access, biometrics, HVAC, medicine dose, thermography, man/machine interfaces, computing platforms and call centers.

44. The decision making system according to claim 32, wherein said sensors comprise at least one of automated voice, touch and home physical system input/output sensors.

45. The decision making system according to claim 32, further comprising means for generating at least one of a voice or electronically instantiated query, sound, optical, motion and a vibration signal to the individual upon the detection of an anomalous pattern of activity.

46. The decision making system according to claim 45, wherein said means for generating is integrated in at least one of a medical device, a device with a processor, a TV, radio, telephone, user I/O device, appliance interlock and physical device interlock.

47. The decision making system according to claim 32, wherein said processes being adjusted comprise at least one of remote and on site adjustment.

48. The decision making system according to claim 32, further comprising a verification system for verifying said output by said decision making system for reducing the chance of a false decision.

49. The decision making system according to claim 32, wherein said decision making system utilizes at least one of a dynamically configured spatial/volumetric simulation space, activity density, sequence and rate, spatial rate variation and activity-resource reconciliation for assessment of at least one of health, activity and safety of the individual based upon at least one of spatial and temporal inferencing.

50. The decision making system according to claim 32, further comprising at least one of logical and reasoned rules for comparing a volumetric and temporal dynamic control volume for persons and activities of the individual.

51. The decision making system according to claim 32, further comprising a plurality of sensors for enabling reasoned inputs and validating reasoning results.

52. The decision making system according to claim 32, wherein said decision making system utilizes at least one of RF and mobile tracking means for assessing the individual's activity, state or quality of health.

53. The decision making system according to claim 32, wherein said decision making system utilizes appliance and utility use or flows to reason on at least one of health, safety and status of at least one of the individual and the individual's environment.

54. The decision making system according to claim 32, wherein said decision making system utilizes Agent Based Modeling to reconcile at least one of time and space appropriateness in activity and status of at least one of the individual and the individual's environment.

55. The decision making system according to claim 32, wherein said decision making system utilizes mutually exclusive time and space continuums to at least reason and infer at least one of health and quality of life of the individual.

56. The decision making system according to claim 32, wherein said decision making system utilizes a plurality of sensors for obtaining time and space logical inputs and outputs for inferring at least one of activity, health, status and quality of life of the individual.

57. The decision making system according to claim 32, wherein said decision making system comprises at least one of automated and manual algorithm learning with training motions and activities to instantiate logic and data baselines.

58. The decision making system according to claim 32, wherein said decision making system comprises continuous learning from at least one of activity, sensed signals, reasoning and feedback for increasing reasoning accuracy.

59. The decision making system according to claim 32, wherein said decision making system comprises product offerings that lower at least one of insurance and reinsurance cost for a given service or risk level.

60. The decision making system according to claim 32, wherein said decision making system comprises means for utilization of more global data in comparative algorithms to assess at least one of attributes and context, the comparative wellness and activity state of one who is monitored.

61. The decision making system according to claim 32, wherein said decision making system comprises means for location of items tagged by RF based upon an automated command to locate and display.

62. The decision making system according to claim 32, wherein said decision making system comprises means for checking activities against forecasted or scheduled activities in assessing at least one of fraud, compliance to contracted terms and conditions, an anomaly and an adequacy of care.

63. A method for facilitating living in a predetermined location for an individual, said method comprising:
monitoring activities of the individual by means of an integrated portfolio of at least one of active and passive sensors;
synthesizing and analyzing signals from said sensors by means of an analyzing system for assessing a status of the individual and inferring the individual's activity, quality of life, status or condition;
generating an output based upon said assessment by means of a decision making system; and
activating processes to respond to said decision making by means of an activation system.

64. The method according to claim 63, further comprising sensing at least one of contact, sound, vibration, temperature, humidity, video, motion, access, telecommunications, computer traffic, HVAC, power, flow of utility services, appliance status, thermography, biometric monitoring and man/machine interfaces by means of said sensors.

65. The method according to claim 63, further comprising monitoring usage of at least one of medical devices, television, radio, computer, exercise equipment and medical equipment for assessment of at least one of health, activity and safety of the individual.

66. The method according to claim 63, further comprising converting raw data from said sensors into a probabilistic assessment of at least one of health, activity and safety of the individual by means of at least one of algorithms, rules engines, decision making systems and workflow in said analyzing system.

67. The method according to claim 63, further comprising utilizing at least one of Artificial Intelligence, Case Based Reasoning, Evidential Reasoning, Data Mining, Rule Base Decisioning and Fuzzy Logic, Agent Based Simulation, System Dynamic Simulation, Discrete Event Simulation and Monte Carlo Simulation in its reasoning within said analyzing system.

68. The method according to claim 63, further comprising utilizing data from at least two of said sensors for assessing the status of the individual and inferring the individual's at least one of quality of life, security, activity, health and status by means of said analyzing system.

69. The method according to claim 68, further comprising utilizing said assessment of status to probabilistically or deterministically determine if an activity is normal or an anomaly, and if said activity is normal as defined by a probability set-point, using said decision making and activation systems to label said activity as normal, but if said activity is an anomaly, using said decision making and activation systems to perform at least one of contacting the individual and sending assistance to the individual.

70. The method according to claim 63, further comprising integrating said method with at least one of a health and owner's insurance to at least one of reduce a cost of said insurance or enhanced care at a given level of said insurance, the owner being one of a home owner, an institution and an insurance company with or without reinsurance.

71. The method according to claim 70, further comprising reducing premium for said level of insurance for extension of in-home living by means of said method.

72. The method according to claim 63, wherein said method facilitates living in at least one of a home of the individual, a hospital, an assisted care facility and an institution.

73. The method according to claim 63, further comprising providing a call center located at a remote location from said predetermined location for analyzing signals from said sensors and analytical results.

74. The method according to claim 63, further comprising generating said output based upon said assessment of values, readings, trends, and pattern recognition from data related to at least one of power use, gas use, water use, video, motion, access, biometrics, HVAC, medicine dose, thermography, man/machine interfaces, computational platform and call centers by means of said decision making system.

75. The method according to claim 63, wherein said sensors comprise at least one of automated voice, motion, touch and home physical system input/output sensors.

76. The method according to claim 63, further comprising generating at least one of a voice or electronically instantiated query, sound, optical, motion and a vibration signal to the individual upon the detection of an anomalous pattern of activity.

77. The method according to claim 63, wherein said generating is integrated in at least one of a medical device, a device with a processor, a TV, radio, telephone, user I/O device, appliance interlock and physical device interlock.

78. The method according to claim 63, wherein said processes being monitored or calibrated comprise at least one of having a remote location and an on site location.

79. The method according to claim 63, further comprising verifying said output by said decision making system for reducing the chance of a false decision.

80. The method according to claim 63, further comprising assessing of at least one of health, activity and safety of the individual based upon spatial inferencing by at least one of utilizing a dynamically configured spatial/volumetric simulation space, activity density, sequence and rate, spatial rate variation and activity-resource reconciliation.

81. The method according to claim 63, wherein said method utilizes at least one of logical and reasoned rules for comparing a volumetric and temporal dynamic control volume for persons and activities of the individual.

82. The method according to claim 63, wherein said method utilizes a plurality of sensors for enabling reasoned inputs and validating reasoning results.

83. The method according to claim 63, wherein said decision making system utilizes at least one of RF and mobile tracking means for assessing the individual's quality of health or life in the context of care.

84. The method according to claim 63, wherein said method utilizes appliance and utility use or flows to reason on at least one of health, safety and status of at least one of the individual and the individual's environment.

85. The method according to claim 63, wherein said method utilizes Agent Based Modeling to reconcile at least one of time and space appropriateness in activity and status of at least one of the individual and the individual's environment.

86. The method according to claim 63, wherein said method utilizes mutually exclusive time and space continuums to at least one of reason and infer at least one of activity, health and quality of life of the individual.

87. The method according to claim 63, wherein said method utilizes a plurality of sensors for obtaining time and space logical inputs and outputs for inferring at least one of health, status and quality of life of the individual.

88. The method according to claim 63, wherein said method comprises at least one of automated and manual algorithm learning with training motions and activities to instantiate logic and data baselines.

89. The method according to claim 63, wherein said method comprises continuous learning from at least one of activity, sensed signals, reasoning and feedback for increasing reasoning accuracy.

90. The method according to claim 63, wherein said method comprises product offerings that lower at least one of insurance and reinsurance cost for a given service or risk level.

91. The method according to claim 63, wherein said method is utilized across a plurality of monitored persons to enable and perform comparative assessments and reasoning.

92. The method according to claim 63, wherein said method comprises utilizing more global data in comparative algorithms to assess at least one of attributes and context, the comparative wellness and activity state of one who is monitored.

93. The method according to claim 63, wherein said method comprises locating items tagged by RF based upon an automated command to locate and display.

94. The method according to claim 63, wherein said method comprises checking activities against forecasted or scheduled activities in assessing at least one of fraud, compliance to contracted terms and conditions, an anomaly and an adequacy of care.
